(19) United States
(12) Patent Application Publication
(10) Pub. No.: US 2013/0159851 A1
(43) Pub. Date: Jun. 20, 2013

(54) METHOD AND SYSTEM FOR PROVIDING HELP CONTENT TO USERS

(71) Applicants: BEWO TECHNOLOGIES PVT.LTD, Bangalore (IN); Neeraj Gupta, Bangalore (IN)

(72) Inventors: SHARAD PAWAR, Bangalore (IN); NEERAJ GUPTA, Bangalore (IN); MANJUNATH GUNDURAO, BANGALORE (IN)

(73) Assignees: BEWO TECHNOLOGIES PVT.LTD, BANGALORE (IN); Neeraj Gupta, Bangalore (IN)

(21) Appl. No.: 13/719,874

(22) Filed: Dec. 19, 2012

(30) Foreign Application Priority Data
Dec. 20, 2011 (IN) 4477/CHE/2011

(51) Int. Cl. G06F 3/0481

(52) U.S. Cl. CPC G06F 3/0481
USPC 715/708; 715/705

(57) ABSTRACT

The various embodiments herein disclose a method of providing help content to users for a plurality of applications installed on the user device to direct users on how to proceed with operation of a particular application. The method comprises selecting an application installed in the user device, activating a help mode function provided in a user device, checking for the help content corresponding to the selected application, connecting the user device to an central server if a help content pertaining to the selected application is not available, synchronizing the selected application with the applications in the central server and extracting the help content for the selected application from the central server to the user device. The activation of the help mode disables the plurality of applications installed in the user device and sets the user device to function under a help mode.

### CROSS-REFERENCE TO RELATED APPLICATION

The present application claims priority of Indian provisional application serial number 4477/CHE/2011 filed on Dec. 20, 2011, and that application is incorporated in its entirety at least by reference.

### BACKGROUND

1. Technical Field

The embodiments herein generally relate to help functions for device applications and particularly to an application for providing context sensitive help information according to the user preferences.

2. Description of the Related Art

Computer applications include a vast number of features, many of which require a user to perform a complicated set of steps. However, performance of such steps is often not intuitive and a user therefore often does not perform the correct steps, therefore failing to accomplish a task the user intended to perform and/or causes an error.

It is conventional to provide a database of user help information so that when the user encounters an error or determines that the user requires instruction on how to proceed, the user may retrieve pertinent information from the database. Also it is conventional to display user help information in response to a user request for help. This requires the user to spend time searching for the correct help topic which however distracts the user from the actual performance of the tasks the user intended to perform.

Many applications provide separate help windows which enables the user to understand the functionalities of the installed application. Such help windows have pre-solved queries which the user generally faces while using the application. But in such applications, the help window covers a large part of the device screen so user has to toggle between the operation window and the help window which in turn is a tedious process. Also the existing help windows have a layered structure which necessitates the user to either minimize or close the preceding windows to come back to the main window.

Though devices with multi-lingual applications are available, the language options in such applications are limited which makes it hard for the person who speak and understand languages that are not provided in the application.

Some applications have help window that are configured to float as a separate window facilitating the user to adjust the help window as per their requirement. But as the help window generally rest over the operating window it becomes difficult to view the progress of the application running in background.

Hence, there is a need for an application which enables the user to understand the salient features of the applications installed on the user device and renders navigational guidance which enables a user to drift through operational features of the application. There also exists a need to provide an application which automatically alerts the user any updates in the features associated with the application. Further, there also exists a need for an application which provides user assistance in a plurality of formats.

The above mentioned shortcomings, disadvantages and problems are addressed herein and which will be understood by reading and studying the following specification.

### SUMMARY

The primary object of the embodiments herein is to provide a method and system for providing help content that facilitates the user to understand the salient features of the application installed on the user device and to extend user assistance in help mode of a user device.

Another object of the embodiments herein is to provide method and system to facilitate the users to edit the information for the application installed on the user device according to the user preferences.

Another object of the embodiments herein is to provide method and system to facilitate the users to add help content for the application installed on the user device locally.

Another object of the embodiments herein is to provide a method and system for providing updates on the help mode information corresponding to the applications installed on the user device.

Another object of the embodiments herein is to provide a method and system which enables the users to set preferences according to their requirements and prioritize their preferences.

Another object of the embodiments herein is to provide a method and system which enables the user to select the user assistance from a plurality of formats such as text mode, voice mode, video mode, graphical mode and the like.

Another object of the embodiments herein is to provide a method and system which enables users to customize the help content to a specific user context.

Another object of the embodiments herein is to provide a method and system to automatically provide help information pertinent to users' needs based on user's previous selection of applications.

Yet another object of the embodiments herein is to provide a method and system which enables the users to view one or more advertisements associated with a selected application/feature.

Yet another object of the embodiments herein is to provide a method and system which enables users with disabilities to use various applications installed on the device.

The various embodiments herein describe a method of providing help content to users. The method comprising steps of selecting an application installed in a user device, activating a help mode function provided in the user device, checking for the help content corresponding to the selected application, connecting the user device to an central server if a help content pertaining to the selected application is not available, synchronizing the selected application with the applications in the central server and extracting the help content for the selected application from the central server to the user device. The activation of the help mode function disables the plurality of applications installed in the user device and sets the user device to function under a help mode.

According to an embodiment herein, the help content comprises a set of instructions related to an operation of the selected application.

According to an embodiment herein, the method further comprises creating the help content for one or more applications locally in the user device if the help content for one or more applications is not available and sharing the created help content over the web.

According to an embodiment herein, the help content comprises a set of pre-recorded instructions embedded with a help mode function for the selected application.

According to another embodiment herein, the help content comprises a set of dynamically generated instructions downloaded from the central server.

According to an embodiment herein, the help content is in at least one of a text format, audio format and video format.

According to an embodiment herein, the help content in the user device is updated by at least one of downloading the help content updates from the central server, creating additional help content locally in the user device and accepting the help content updates provided by one or more vendors in response to an application update.

According to an embodiment herein, the user is at least one of an entity including an individual, a vendor, an organization, a company and any equivalent thereof.

According to an embodiment herein, the help mode function is adapted for at least one of enabling the user to understand one or more key features of the application, providing ease of navigation through the application, editing details of the application, suggesting the application updates to the user at regular intervals, setting the user preferences for other applications in the user device which have priority over the updates provided by the central server, suggesting the help content based on the users previous selection of applications, customizing the help content in accordance with a usage context, providing additional online help content to one or more users based on the context data, and enables the user to set preferences for help mode function including schema, color, language and the like.

According to an embodiment herein, the help mode function is further adapted for displaying a plurality of advertisements on the user device and providing a help content related to each of the plurality of advertisements.

According to an embodiment herein, activating the help mode function for the selected application disables the plurality of applications installed in the user device.

The embodiments herein further provide a method of providing a help content update to a plurality of user devices corresponding to an application update. The method comprising steps of registering a plurality of application vendors with an central server, requesting to the central server to upload the help content when there is an application update, verifying the authenticity of the plurality of vendors and the help content updates provided by the application vendors, allowing the application vendors to upload the update information in the central server on successful verification of the plurality of vendors, notifying the user regarding the help content updates when the user connects to the central server and updating the help content in the user device on accepting the help content update notification.

The various embodiments herein provide a system for providing help content to users. The system comprises a central server, a plurality of user devices connected to the central server, a help mode function installed on the plurality of user devices and a help mode interface for the help mode function to interact with the central server. The help mode interface is adapted to select an application installed in the user device, activate a help mode function provided in the user device, check for the help content corresponding to the selected application, connect the user device to the central server if a help content pertaining to the selected application is not available, synchronize the selected application with the applications in the central server, and extract the help content for the selected application from the central server to the user device.

According to an embodiment herein, further comprising a help menu tab provided on the help mode interface of the user device to provide the help content to the users, where the help content comprises operational guidance and features pertaining to one or more application installed in the user device.

According to an embodiment herein, the help mode function is installed as a part of an application installed on an operating system level of the user device.

According to an embodiment herein, the help mode function is downloaded from the central server and installed in the user device.

According to an embodiment herein, the central server comprises an application repository for storing a plurality of applications and the help content associated with each of the plurality of applications, a synchronization module for synchronizing the applications in the user device with the applications in the central server and a database to store an help content update information.

According to an embodiment herein, the system further comprises a plurality of vendors registered with the central server to provide help content updates associated with the plurality of applications.

According to an embodiment herein, the central server further comprises an interface to enable the plurality of vendors to upload the help content updates, notify the users the availability of additional help contents corresponding to one or more applications and provide the details of the help content updates to the user device.

According to an embodiment herein, the user device comprises at least of one of a mobile phone, tablet device, PDA, laptop, desktop and the like.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications can be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a block diagram illustrating the operation of a user device in a help mode according to an embodiment of the present disclosure.

FIG. 2 is a block diagram illustrating a plurality of user devices in conjunction with a central server for obtaining help content, according to another embodiment of the present disclosure.

FIG. 3 is a scenario diagram illustrating a process flow for providing help content to users, according to an embodiment of the present disclosure.

FIG. 4 is a block diagram illustrating a plurality of user device in conjunction with a plurality of application vendors through a central server, according to another embodiment of the present disclosure.

FIG. 5 is a flow chart illustrating a method for providing help mode information to users according to an embodiment of the present disclosure.

FIG. 6 is a flow chart illustrating a method for providing help content updates to user devices corresponding to application updates according to an embodiment of the present disclosure.

Although the specific features of the present embodiments are shown in some drawings and not in others. This is done for convenience only as each feature can be combined with any or all of the other features in accordance with the present embodiments.

### DETAILED DESCRIPTION OF THE EMBODIMENTS

In the following detailed description, a reference is made to the accompanying drawings that form a part hereof, and in which the specific embodiments that can be practiced is shown by way of illustration. These embodiments are described in sufficient detail to enable those skilled in the art to practice the embodiments and it is to be understood that the logical, mechanical and other changes can be made without departing from the scope of the embodiments. The following detailed description is therefore not to be taken in a limiting sense.

The various embodiments herein describe a method and system for providing help content related to the functions/features of the plurality of applications installed on the user device to direct users on how to proceed for a particular service/operation. The method comprising steps of selecting an application installed in the user device, activating a help mode function provided in the user device, checking for the help content corresponding to the selected application, connecting the user device to an central server if a help content pertaining to the selected application is not available, synchronizing the selected application with the applications in the central server and extracting the help content for the selected application from the central server to the user device. The method further comprises creating the help content for one or more applications locally in the user device if the help content for one or more applications is not available and sharing the created help content over the web.

The help content herein refers to a set of pre-recorded instructions embedded with a help mode function for the selected application or a set of dynamically generated instructions downloaded from the central server in at least one of a text, audio or video format.

As used herein, the user refers to any entity that can access and potentially utilize help content including an individual, a vendor, an organization, a company, and/or any equivalents thereof. The user device refers to any computing device including mobile phones, tablet devices, PDAs, laptops, desktops and the like.

The help content in the user device is updated by at least one of downloading the help content updates from the central server, creating additional help content locally in the user device and accepting the help content updates provided by one or more vendors in response to an application update.

The help mode function is further adapted for displaying a plurality of advertisements on the user device and providing a help content related to each of the plurality of advertisements.

The users can activate the help mode function according to their preferences. Once the help mode function is activated, all the applications running in the user device gets inactive and the help mode function completely governs the operation of the user device.

The help mode function is adapted for at least one of enabling the user to understand one or more key features of the application, providing ease of navigation through the application, editing details of the application, suggesting the application updates to the user at regular intervals, setting the user preferences for other applications in the user device which have priority over the updates provided by the central server, suggesting the help content based on the users previous selection of applications, customizing the help content in accordance with a usage context, providing additional online help content to one or more users based on the context data, and enables the user to set preferences for help mode function including schema, color, language and the like.

The user device further comprises a plurality of applications controlled by the respective application vendors respectively. The help mode function herein enables the user to set the user's preferences for other applications in the user device which have priority over the updates provided by the central server.

The application vendor associated with the already installed applications as well as newly installed applications registers themselves with the central server. During any update on the respective applications' help content, the application vendor sends a request to the central server to upload the help content update. The central server first verifies the authenticity of the information provided by the application vendors and further allows the application vendors to upload the available information (help content update) in central server's database. Whenever users connect their device with the central server, the central server intimates the user about the update available for respective applications' help content. The user can either accept or reject the application updates suggested by the central server based on their requirements. If the user accepts the auto-update request from the central server, the features of the corresponding application gets changed according to the update which gets reflected in the user device thereon. If the user rejects the auto-update request from the central server, the features, date and time of update remains intact as last updated. After the details are updated, when the user activates the application in help mode, the updated details are displayed. The date and time of the recent update is displayed along with the details of the application.

The various embodiments herein provide a system for providing help content to users. The system comprises a central server, a plurality of user devices connected to the central server, a help mode function installed on the plurality of user devices and a help mode interface for the help mode function to interact with the central server. The help mode interface is adapted to select an application installed in the user device, activate a help mode function provided in the user device, check for the help content corresponding to the selected application, connect the user device to the central server if a help content pertaining to the selected application is not available, synchronize the selected application with the applications in the central server, and extract the help content for the selected application from the central server to the user device.

The help mode function further comprises a help menu tab provided on the help mode interface of the user device to provide the help content to the users, where the help content comprises operational guidance and features pertaining to one or more application installed in the user device.

The help mode function is installed as a part of an application installed on an operating system level of the user device or the help mode function is downloaded from the central server and installed in the user device.

The central server comprises an application repository for storing a plurality of applications and the help content associated with each of the plurality of applications, a synchronization module for synchronizing the applications in the user device with the applications in the central server and a database to store an help content update information.

The system further comprises a plurality of vendors registered with the central server to provide help content updates associated with the plurality of applications.

The central server further comprises an interface to enable the plurality of vendors to upload the help content updates, notify the users the availability of additional help contents corresponding to one or more applications and provide the details of the help content updates to the user device.

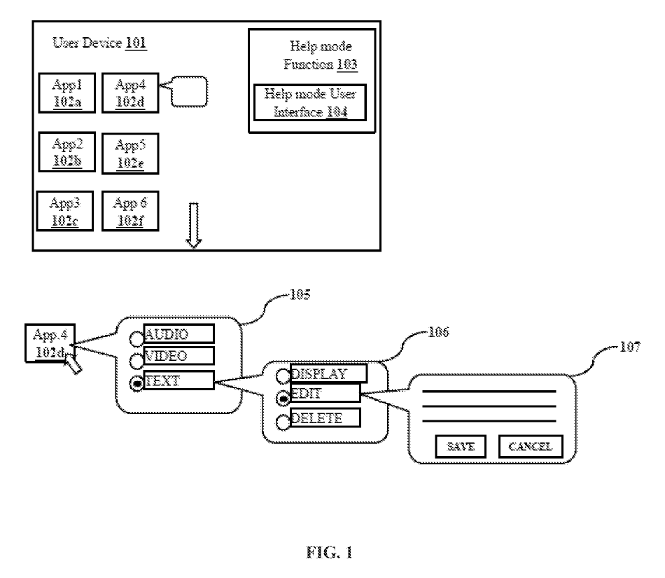

FIG. 1 is a block diagram illustrating the operation of a user device in a help mode according to an embodiment of the present disclosure. The user device 101 includes a plurality of applications 102a-102f installed therein. The user device 101 is provided with a help mode function 103 which is inbuilt in the device or the user can download the help mode function from a central server and install in the user device. On successful installation of the help mode function 103, a help mode user interface 104 appears on the user device screen. The user activates the help mode function 103 to obtain help content relating to the operational features, functions and other related information associated with a particular application, for example App4 102d as shown in FIG. 1. When the user clicks on the help mode interface 104, all the applications (including the selected application) installed on the user device 101 gets inactive and the user device 101 starts working completely under the help mode supervision.

When the user selects a particular application for help content, the help mode function 103 provides a plurality of formats such as text mode, video mode and audio mode of the help contents 105. The user selects a particular format in accordance with their requirements and preferences, for instance, text mode. The help mode function further provides the user's further options of display, edit and delete 106 on the user device 101. When the user selects the edit option, the help content appears with further options of saving and cancelling 107 the modifications. The user then can either save or cancel the modifications they have made to that application based on the user preferences.

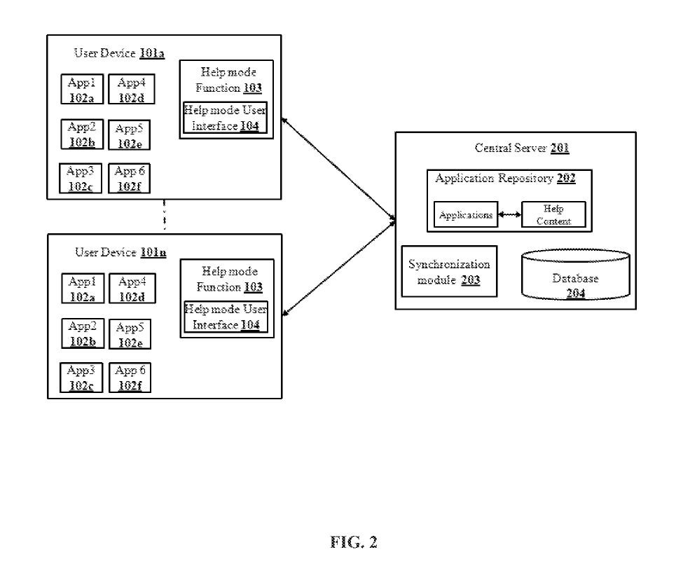

FIG. 2 is the block diagram illustrating a plurality of user devices connected to a central server for obtaining the help contents, according to another embodiment of the present disclosure. If the user devices (101a-101n) are not provided with help contents pertaining to specific applications, the user request the central server 201 to provide the help contents. The user connects with the central server 201 over a communication network such as internet to obtain the application specific help contents. The central server 201 is a controlling server for the help mode function 102 which stores the help contents of the application specific software for the help mode 102, update details of the help mode function as well as update regarding the help content for the other applications installed on the user device 101. The central server 201 stores the help content in an application repository module 202 of the central server 201. Whenever the user device 101 is connected to the central server 201, the central server 201 activates a synchronization module 203 for synchronizing the applications in the user device 101 with the application in the central server 201. If the application installed on the user device 101 is synchronized with the application in the central server 201, the central server 201 provides the help content to the user device 101 in response to a help content request received from the user.

In an embodiment herein, if the user devices does not have the help content for one or more applications, the users can create the help content locally in the user device and share the created help content over the web.

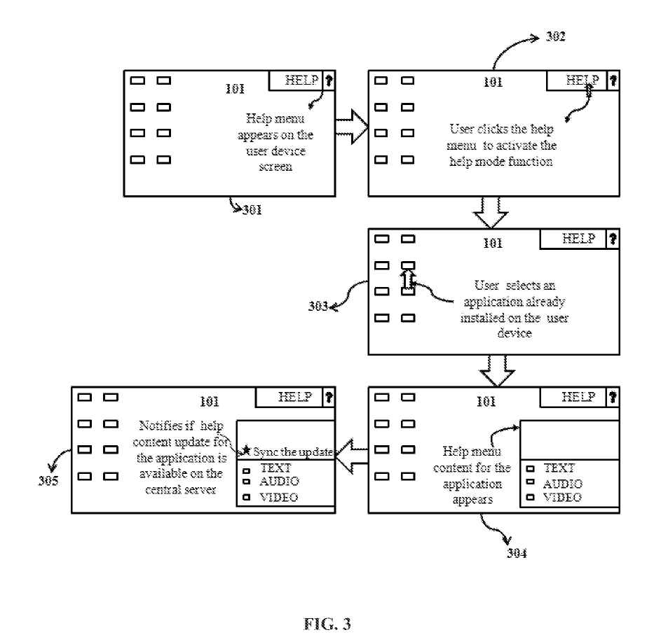

FIG. 3 is a scenario diagram illustrating a process flow for providing help contents to users, according to an embodiment of the present disclosure. The flow diagram illustrates various processes including a help mode function installation in the user device 101, appearance of the help mode interface on the user device 101 and providing the various options (display, edit and delete) to the user. The user either downloads the help mode function 103 from the central server or installs the application in the user device 101 or the respective help mode function is inbuilt in the user device 101. After the installation, the help mode interface appears (301) on the screen of the user device. When the user activates the help mode function by clicking on the help mode interface, the other applications get inactive (302). Further the user double-clicks on the application icon whose help content is required by the user (303). The help content for the selected application appears on the user device screen in a format (audio, text or video) selected by the user (304). The help mode function provides various options for displaying, editing and deleting the help content for the user. Further the central server sends a notification (305) to the user device on any update regarding the help content of a particular application installed on the user device when the device is connected to the central server.

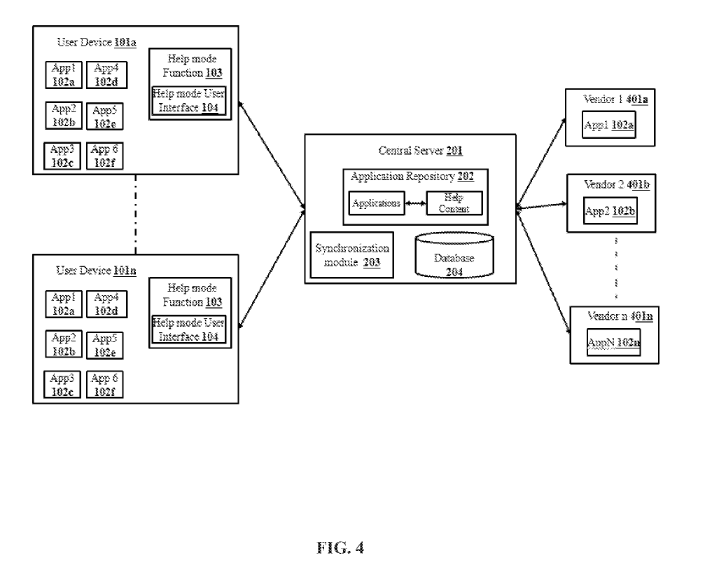

FIG. 4 is a block diagram illustrating a plurality of user devices in conjunction with a plurality of application vendors through a central server, according to another embodiment of the present disclosure. The plurality of application vendors 401a-401n registers with the central server by providing a plurality of credentials. When there is an update on any the application software, the vendors would correspondingly update the help contents associated with the updates as well. The plurality of vendors 401a-401n connects to the central server 201 and the central server 201 after necessary verifications allows the plurality of vendors 401a-401n to upload the updated help contents in the central server 201. When the user connects to the central server 201 for obtaining the help content or for any application execution, the central server 201 sends a notification to the user device 101 notifying the availability of additional help contents corresponding to particular applications. The central server 201 also provides the details of the updates to the user device. The user can either accept the update request or reject the update request based on their requirements and application usability in help mode.

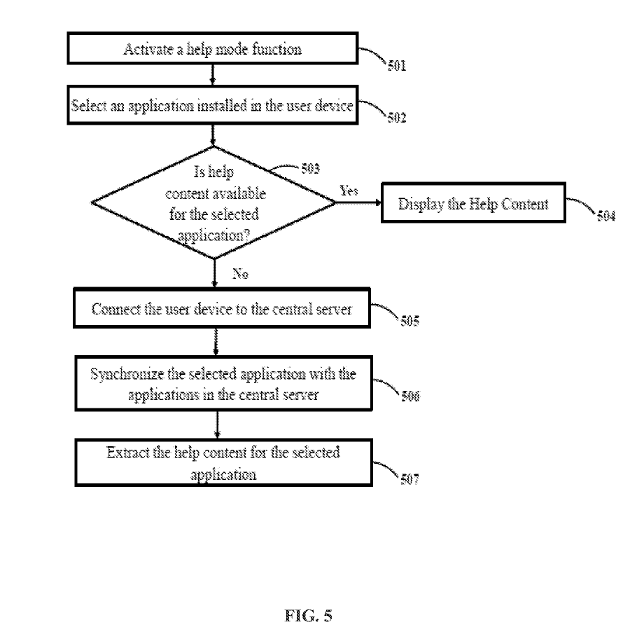

FIG. 5 is a flow chart illustrating a method for providing help mode information to users according to an embodiment of the present disclosure. At 501, the user activates a help mode function installed on the user device. When the user activates the help mode, the other applications installed on the user device gets inactive. After activating the help mode, the user selects an application by clicking on application icon according to their requirements at 502. The user then checks whether the help content is available for the selected application in the user device or not at 503. If the help content is available for the selected application, the user device displays the help contents to the user at 504. If the help content is not available on the user device, the user connects the user device to a central server at 505 and synchronizes the selected application with the application in central server 506. If the applications are synchronized by the synchronization module in the central server, the user device requests the central server to provide the help contents. At 507, the user extracts help content corresponding to the application to the user device from the central server.

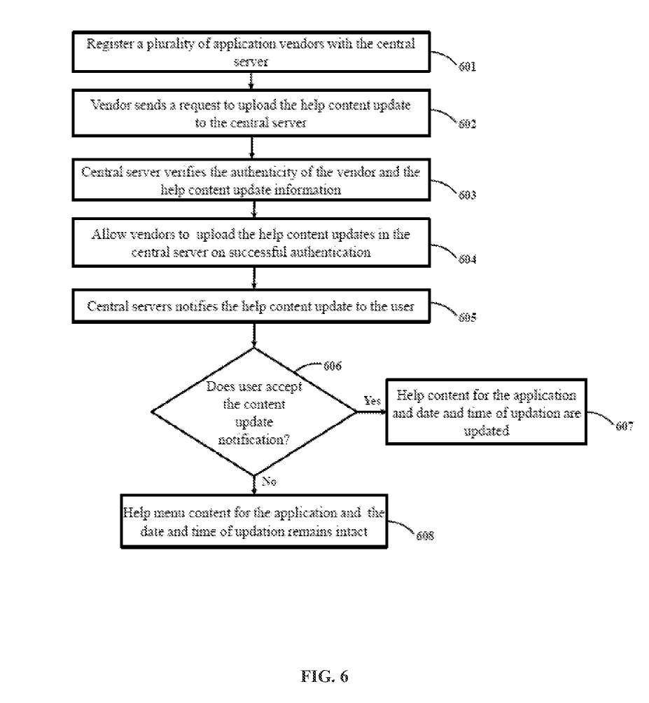

FIG. 6 is a flow chart illustrating a method for providing help content updates to user devices corresponding to application updates according to an embodiment of the present disclosure. A plurality of application vendors registers with the central server at 601. The application vendor sends a request to the central server to upload the help content updates to the central server whenever an application update is performed at 602. The central server verifies the authenticity of the plurality of vendors and the information regarding the help content provided by the application vendors at 603. On successful verification of the plurality of application vendors, the central server allows the application vendors to upload the update information in the central server database at 604. At 605, the central server notifies the user regarding the help content updates when the user connects to the central server. The user makes the final decision whether to accept or reject the help content update suggestions provided by the central server at 606. If the user accepts the help content updates, the information regarding the corresponding help content is updated along with date and time of update in the user device at 607. If the user rejects the help content update suggestion, the information for the corresponding help content of selected application remains intact at 608.

The embodiments herein enables the user to understand the salient features of the application installed on the user device and provides navigation assistance to users in a help mode of a user device. The embodiments herein also enable the user to update the details of any application installed on the user device according to user preferences during a help mode of the user device and facilitate the user to set the details of the application in a more understandable way which is easier to the user. The application provides the users to set the details in any of a text, audio or video mode according to their convenience.

The embodiments herein function as an assistant application to assist a user in interacting with smart devices; especially for users with disabilities such as vision impairment/physically challenged and enables the vendors to provide advertisements to the user device without additional cost and effort.

The embodiments herein does not require any additional memory or processors for accessing help contents from server or any other storage location as all the updates are automatically stored in the user device memory itself.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification.

What is claimed is:

1. A method of providing help content to users, the method comprises:
selecting an application installed in an user device;
activating a help mode function provided in the user device;
checking for the help content corresponding to the selected application;
connecting the user device to an central server if a help content pertaining to the selected application is not available;
synchronizing the selected application with the applications in the central server; and
extracting the help content for the selected application from the central server to the user device;
wherein activating the help mode function disables the plurality of applications installed in the user device and sets the user device to function under a help mode.

2. The method of claim 1, wherein the help content comprises a set of instructions related to an operation of the selected application.

3. The method of claim 1, further comprises:
creating the help content for one or more applications locally in the user device if the help content for one or more applications is not available; and
sharing the created help content over the web.

4. The method of claim 1, wherein the help content comprises a set of pre-recorded instructions embedded with a help mode function for the selected application.

5. The method of claim 1, wherein the help content comprises a set of dynamically generated instructions downloaded from the central server.

6. The method of claim 1, wherein the help content is in at least one of a text format, audio format and video format.

7. The method of claim 1, further comprises updating the help content in the user device by at least one of:
downloading the help content updates from the central server;
creating additional help content locally in the user device; and
accepting the help content updates provided by one or more vendors in response to an application update.

8. The method of claim 1, wherein the user is at least one of an entity including an individual, a vendor, an organization, a company and any equivalent thereof.

9. The method of claim 1, wherein the help mode function is adapted for at least one of:
enabling the user to understand one or more key features of the application,
providing ease of navigation through the application,
editing details of the application; and
suggesting the application updates to the user at regular intervals;
setting the user preferences for other applications in the user device which have priority over the updates provided by the central server,
suggesting the help content based on the users previous selection of applications;
customizing the help content in accordance with a usage context;
providing additional online help content to one or more users based on the context data; and
enables the user to set preferences for help mode function including schema, color, language and the like.

10. The method of claim 1, wherein the help mode function is further adapted for:
displaying a plurality of advertisements on the user device; and
providing a help content related to each of the plurality of advertisements.

11. The method of claim 1, wherein activating the help mode function for the selected application disables the plurality of applications installed in the user device.

12. A method of providing a help content update to a plurality of user devices corresponding to an application update, the method comprises:
registering a plurality of application vendors with an central server;
requesting to the central server to upload the help content when there is an application update;
verifying the authenticity of the plurality of vendors and the help content updates provided by the application vendors;
allowing the application vendors to upload the update information in the central server on successful verification of the plurality of vendors;
notifying the user regarding the help content updates when the user connects to the central server; and
updating the help content in the user device on accepting the help content update notification.

13. A system for providing help content to users, the system comprises:
an central server,
a plurality of user devices connected to the central server,
a help mode function installed on the plurality of user devices; and
a help mode interface for the help mode function to interact with the central server to:
select an application installed in the user device;
activate a help mode function provided in the user device;
check for the help content corresponding to the selected application;
connect the user device to the central server if a help content pertaining to the selected application is not available;
synchronize the selected application with the applications in the central server; and
extract the help content for the selected application from the central server to the user device.

14. The system of claim 12, further comprise a help menu tab provided on the help mode interface of the user device to provide the help content to the users, where the help content comprises operational guidance and features pertaining to one or more application installed in the user device.

15. The system of claim 12, wherein the help mode function is installed as a part of an application installed on an operating system level of the user device.

16. The system of claim 12, wherein the help mode function is downloaded from the central server and installed in the user device.

17. The system of claim 12, wherein the central server comprises:
an application repository for storing a plurality of applications and the help content associated with each of the plurality of applications;
a synchronization module for synchronizing the applications in the user device with the applications in the central server; and
a database to store an help content update information.

18. The system of claim 12, further comprises a plurality of vendors registered with the central server to provide help content updates associated with the plurality of applications.

19. The system of claim 17, wherein the central server further comprises an interface to:
enable the plurality of vendors to upload the help content updates;
notify the users the availability of additional help contents corresponding to one or more applications; and
provide the details of the help content updates to the user device.

20. The system of claim 12, wherein the user device comprises at least of one of a mobile phone, tablet device, PDA, laptop, desktop and the like.
